(19) United States
(12) Patent Application Publication
(10) Pub. No.: US 2017/0336233 A1
(43) Pub. Date: Nov. 23, 2017

(54) METHOD FOR DETERMINING A GAS AMOUNT AND DEVICE FOR CARRYING OUT SAID METHOD

(71) Applicant: HYDAC ACCESSORIES GMBH, Sulzbach/Saar (DE)

(72) Inventors: Helmut HISS, Ispringen (DE); Martin SCHMITT, Knopp-Labach (DE)

(21) Appl. No.: 15/532,547

(22) PCT Filed: Nov. 17, 2015
(86) PCT No.: PCT/EP2015/002298

§ 371 Date: Jun. 2, 2017

(30) Foreign Application Priority Data
Dec. 6, 2014 (DE) 10 2014 018 099.9

(51) Int. Cl. G01F 5/00

(52) U.S. Cl. CPC G01F 5/00

(57) ABSTRACT

A method is for determining a gas amount, which can be dispensed by a dispensing device, in particular in the form of a hydrogen gas amount, by a gas meter (36). A part of the main gas stream flowing to the dispensing device (26) is branched off by a flow divider (20) mounted upstream of the dispensing device (26), when viewed in the direction of the gas stream, for a quantitative measurement in the secondary flow by the gas meter (36).

### FIELD OF THE INVENTION

The invention relates to a method for determining a gas amount, which can be dispensed by a dispensing device, in particular in the form of a hydrogen gas amount, by a gas meter. The invention furthermore relates to a measuring device for carrying out this method.

### BACKGROUND OF THE INVENTION

According to the most recent Wikipedia entry, a gas meter is a measuring apparatus for determining a gas amount throughput in a determined period of time. Such gas meters are used mainly in the supply of gas to households. They are also used for precise quantification in drilling tests. The unit recorded by the gas meter is the cubic meter in the respective operating state, which must be converted into standard cubic meters for accounting purposes. The gas meters are also regularly subjected to an obligatory calibration, and gas meters may be equipped with appropriate interfaces for the purpose of remote retrieval of meter readings.

The prior art has found using Coriolis mass flow meters for gas quantification particularly advantageous. The apparatus is a flow measuring device that can particularly precisely measure the mass flow of through-flowing liquids or gases. The measuring method is based on the Coriolis principle.

However, the measuring devices that have been proven to be effective, including the in principle precise measuring methods according to the Coriolis principle can often no longer be reliably employed when gases with too low a throughput can no longer be detected in a precise manner. A prerequisite flow throughput is needed for reliable determination by the known measuring methods and measuring devices of a gas amount that can be dispensed by a dispensing device.

In addition to battery-powered electric vehicles, by way of another alternative to petroleum- and natural gas-powered vehicles, hydrogen is becoming increasingly popular as an additional power source. The major advantage compared with battery-powered vehicles at least currently is that, in a manner comparable to traditional fuels such as gasoline or diesel fuels, prompt refueling with hydrogen is possible at filling stations using appropriate tank devices. Appropriate technically modified delivery nozzle is part of the tank dispensing device. With an extensive worldwide network of filling stations already existing, the filling stations can be relatively easily converted for hydrogen dispensing, and thus, be expanded to supplement traditional fuel dispensing or to substitute it. A hydrogen filling station user, in the same way as for conventional fuel dispensing, must of course know exactly what quantity of hydrogen he has put in his tank because, just like traditional fuel, this “propellant”, also has to be paid for at the filling station.

When such filling station hydrogen dispensing devices are equipped with the traditional gas meters as described above, they are in some cases not at all technically suitable for the dispensing of hydrogen. In particular, with hydrogen at relatively low temperatures, the devices do not permit precise measurement of the dispensing quantity. Measuring errors in a range exceeding 3% are very common. An end user would hardly be prepared to tolerate such deviations.

### SUMMARY OF THE INVENTION

The problem addressed by the invention is to provide an improved method and an improved device for carrying out this method using a suitable gas meter. By the meter gases, in particular in highly-pressurized form, can be safely and reliably determined on the basis of their dispensing quantity. This problem is solved by a method according to the configuration of and a measuring device having the features of the invention.

The invention provides that, a part of the main flow flowing to the dispensing device is branched off by a flow divider. The flow divider is mounted upstream of the dispensing device, when viewed in the direction of the gas mass flow, for a quantitative measurement in the secondary flow by the gas meter. The gas mass flow, which is dispensed in the direction of the dispensing device often in the form of a delivery nozzle of a refueling device and which is therefore constantly changing depending on the refueling situation, is proportionately divided or split up by the flow divider. The smaller mass flow in the secondary flow is not returned to the main conduit or main flow. Instead a return is only “simulated” by continuously aligning the pressure of the smaller mass flow in the secondary flow with the pressure in the main flow, which is applied at the outlet side on the flow divider connected in a fluid-conducting or medium-conducting manner to the dispensing device. With a relatively small gas amount in the secondary flow compared with the main flow, which gas amount has the same state as the gas in the main flow, determining the precise dispensing quantity by a gas meter is then possible because in this respect the conditions during dispensing in the main flow are then identical to those in the measuring branch of the secondary flow.

A pressure differential control valve is used for this alignment of the pressure after the flow divider outlet into the main flow and secondary flow. If the pressure in the secondary flow line is higher than in the main flow line, the gas amount in the secondary flow is then transferred via the pressure control valve to a measuring line connected to this valve for as long as it takes for a pressure balance to be restored. In the case of another deviation therefrom, the adjustment operation by the valve is then recommenced. Once it has passed through this valve, the gas is then transferred via the measuring line at a low pressure level to a heat exchanger and brought to ambient temperature.

The thus tempered and expanded measuring gas in the secondary conduit or in the measuring line is then, after passing through the heat exchanger, supplied to a preferably calibrated low pressure gas meter. The meter in turn has on the outlet side a prestressing device, in particular in the form of a spring-loaded check valve, to thus keep the flow rate at the upstream gas meter as constant as possible with a predefinable opening pressure, so as to not prejudice the quality of the measurement.

The gas coming from the low pressure gas meter is then proportional to the mass in the main flow, irrespective of the actuation status of the dispensing device, which is often in the form of the delivery nozzle at the hydrogen filling station. The gas coming from the low pressure gas meter is thus also proportional when calculated in standard cubic meters to the gas dispensed at the delivery nozzle. In the low pressure gas meter itself, a detection of pressure and temperature of the gas to be measured occurs as well as a precisely calibrated conversion into the standard cubic meters or mass by an electronic volume converter.

The gas discharging from the low pressure gas meter can then be subsequently fed back into the tank system or emitted into the environment, since these gases are only very small hydrogen gas amounts, which can then be emitted into the environment without presenting any risk to the environment or to safety.

The solution according to the invention does not have to be limited to hydrogen applications, but can be used generally for the quantitative measurement of any gases, in particular when volumetric gas amounts must be determined in a highly precise manner. The dispensing device can to this extent also be formed by any other consumer that is connected to a gas supply network. However, solely due to the equipment outlay, the method according to the invention and the measuring device for carrying out this method are in any case particularly suited to highly-pressurized gases. The gas amounts that can be dispensed by the dispensing device can be determined on the basis of their amount or of their mass with an accuracy of less than 1% error deviation. There is no equivalent thereof in the prior art. The method according to the invention and the measuring device solution for the first time permits envisaging in a practical manner a hydrogen gas dispensing by tanking up at traditional filling stations of a filling station network.

With regards to the refueling operation, the following information is also to be noted. The maximum mass flow rate is obtained approximately in the middle of refueling. At the start of the refueling operation however, the gas to be dispensed has very high flow rates and a low density. At the end of the tanking operation, these conditions are reversed. and there are then very low flow rates for the gas to be dispensed and, by contrast, a high density. A low gas mass flow rate is thus to be anticipated at the start and at the end of the refueling, which correspondingly complicates the determination of the amount or the mass of the gas to be paid for and to be dispensed at the filling station.

Other objects, advantages and salient features of the present invention will become apparent from the following detailed description, which, taken in conjunction with the drawings, discloses a preferred embodiment of the present invention.

### BRIEF DESCRIPTION OF THE DRAWINGS

Referring to the drawings that form a part of this disclosure and that are schematic and not to scale:

FIG. 1 is a fluid connection diagram of the basic construction of the measuring device according to an exemplary embodiment of the invention, with reference to a practical example in the form of the dispensing of hydrogen that can be tanked up with at a hydrogen filling station;

FIG. 2 is a perspective view of the essential components of the measuring device and a dispensing device connected thereto in the form of a hydrogen tanking nozzle according to the exemplary embodiment of the invention;

FIG. 3 is a side view in section of a flow divider required as part of the measuring device according to the exemplary embodiment of the invention;

FIGS. 4a, 4b, 5a and 5b are a top view, a side view in section, a top view and a side view in section, respectively, of individual diaphragm bodies, as used for the flow divider according to FIG. 3; and

FIG. 6 is a side view in section of a mechanically working differential control valve, as is required to adjust the gas pressure in the secondary flow to the extraction pressure in the main flow according to the exemplary embodiment of the invention.

### DETAILED DESCRIPTION OF THE INVENTION

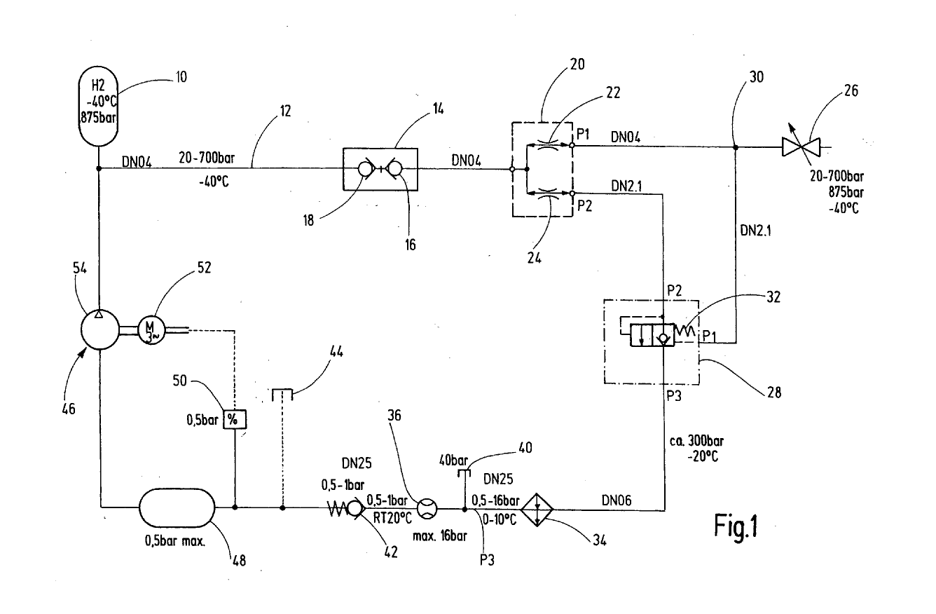

Firstly, the basic construction of the measuring device according to an exemplary embodiment of the invention shall be explained in greater detail with reference to the connection depiction according to FIG. 1. FIG. 1 thus symbolically depicts a filling station storage 10, which is connected at the outlet side to a dispensing network 12 of a filling station that is not depicted in greater detail. A coupling point 14 is used for the connection of the measuring device to the dispensing network 12, at which coupling point a tank nipple 16 can be connected in a detachable manner to a filling nipple 18 of the dispensing network 12. When the two nipples 16, 18 are correspondingly coupled via the coupling point 14, a fluid-conducting or medium-conducting passage is created from the filling station storage 10 to a flow divider 20.

Using individual diaphragms 22, 24, the flow divider 20 divides the gas flow flowing towards its inlet side P0 at a specifiable flow divider ratio into a main flow P1 and a secondary flow P2. A flow divider ratio of the secondary flow P2 to the main flow P1 of 1:64 has proved to be particularly suitable. However, other division ratios are also possible here, for example 1:50 or 1:100. For the measurement in the secondary flow P2, only a partial amount that is significantly smaller compared with the main flow P1 is important to e branched off by the flow divider 20. On the dispensing side of the flow divider 20, a dispensing device 26 is connected to the line with the main flow P1, which dispensing device is in the form of a hydrogen dispensing delivery nozzle here.

The line carrying the secondary flow P2 is connected to the inlet of a differential control valve 28, so that the secondary flow P2 is conveyed between the diaphragms 24 of the flow divider 20 and the inlet or inflow side of the differential control valve 28. On the two opposite control sides of the valve 28, the control pressure is applied to the secondary flow P2 and the gas pressure is applied to the main flow P1, which, tapped before the dispensing device 26 in the main flow P1, is conducted via a branching point 30 to the one control side of the control valve 28. The control valve 28 additionally experiences a holding shut in its unactuated locking position depicted in FIG. 1 by a suction operation on the dispensing side of the control valve 28, which is thus formed by the measuring line P3. This holding shut is symbolically depicted in FIG. 1 with regards to the control valve 28 by the pressure spring 32 acting as an energy storage. When the pressure in the main flow P1 is equal to the pressure in the secondary flow P2, the valve is closed.

Measuring line P3 coming from the control valve 28 is connected to the outlet side thereof, and the measuring line P3 continues onwards to a gas meter 36, which is in particular formed as a low pressure gas meter. A heat exchanger 34 is connected between the control valve 28 and the gas meter 36, which heat exchanger, formed as a spiral, brings the gas coming from the valve 28 to room temperature RT or ambient temperature, and at the same time expands it, for example brings the gas from 300 bar to 0.5 to 16 bar (cf. the relevant details in FIG. 1). A bursting disk 40 can in turn be arranged between the outlet side of the heat exchanger 34 and the inlet side of the gas meter 36. The bursting disk 40 forms an overpressure protection so that it will burst in the event of an incident, e.g., at too high a pressure, in order to thus protect the sensitive gas meter 36 against overpressure or pressure pulsations. A prestressing device 42 is connected on the outlet side of the gas meter 36, which prestressing device is formed in particular in the form of a spring-loaded check valve with an opening pressure of 0.5 to 1 bar. The direction of closing of the check valve is in the direction of the outlet side of the gas meter 36 and cooperates with same. In addition, an electronic volume converter 38 is connected to the gas meter 36.

The gas allowed through by the prestressing device 42 in the opened state can then optionally either be discharged into the environment via a chimney 44 or returned to the filling station storage 10 by a combined compressor/storage device 46. For this purpose, the device 46 has a collection tank 48 and a readings recorder 50, which actuates an electric motor unit 52 in the case of a correspondingly filled tank 48. The motor unit 52 drives a compressor 54, which extracts the gas from the collection tank 48 and returns it to the filling station storage means 10.

With regards to the dimensioning of the overall system in accordance with the connection diagram depiction according to FIG. 1, the following information is noted. In the filling station storage 10, hydrogen gas is frequently stored at −40° C. and 875 bar working pressure. The hydrogen gas is pure, highly-pressurized hydrogen. Both in the dispensing network 12 and on the main flow side P1 line cross sections DN04 are used with a compressive strength of PN875. This results in a gas amount of 2403 Nm3/h (standard cubic meters per hour) at a hypothetical flow rate of 60 grams/second. The proportional flow divider ratio of 1:64 in the flow divider 20 results in a flow rate of approx. 1 gram/second in the secondary flow P2, which corresponds to 11.2 liters/second or 40 Nm3/h. A maximum pressure difference Δp of approximately 5 bar is then obtained between the inlet side P0 and the outlet side of the flow divider 20 both on the main flow side P1 and in the secondary flow P2. The line cross sections DN04, DN2.1 and DN25 used for the individual line sections are also depicted FIG. 1.

Instead of another merging of the gas flow divided by f the flow divider 20, the pressure at the outlet of the differential control valve 28, in other words, at the point of the connected measuring line P3, is maintained by this control valve 28 at exactly the same pressure as the pressure in the main flow P1 between the flow divider 20 and the dispensing device 26 in the form of the delivery nozzle. The hysteresis of the control valve 28 should preferably be less than 0.6 bar. The gas, which is dispensed by the differential control valve 28 and is in particular “blown off” and which is brought to ambient temperature by the heat exchanger 34, expands and is then constantly converted to standard cubic meters and added up by the gas meter 36 calibrated to a maximum of 25 Nm3/h at a dynamic pressure of 1 bar.

Line cross section DN25 having the stability PN16 are used in this area. In addition, at a mass flow of 1 gram hydrogen/second, a volume of 20.16 Nm3/h at 1 bar prestress pressure is obtained in the measuring branch of the measuring line P3, which passes through the gas meter 36. The thus measured gas, which is stored by the check valve of the prestressing device 42 preferably with this 1 bar of opening pressure, is then, as already stated, either discharged into the environment via the chimney 44 or conveyed to the compressor/storage device 46 for the purpose of feeding back to the filling station storage means 10. The electronic volume converter 38 allows the pressure and temperature fluctuations inside the gas meter 36 to be determined. Those fluctuations then correspondingly serve to determine the gas volume at room temperature and normal air pressure that value is required by the user for exact monetary accounting for the hydrogen gas amount dispensed via the delivery nozzle of the dispensing device 26.

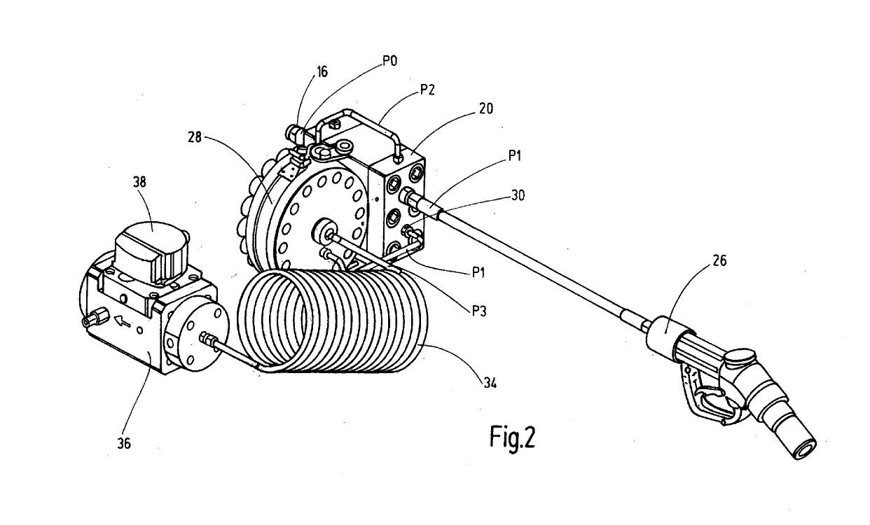

The principle of flow divider measurement illustrated by way of an example in FIG. 1 can of course also be used for larger gas amounts and other line nominal diameters. The respective pressures or pressure ranges and the temperatures to be anticipated including the line cross sections and pressure parameters are correspondingly specified in FIG. 1, wherein the abbreviation RT stands for room temperature. FIG. 2 shows the corresponding components of the connection depiction according to FIG. 1 with their specific structural design, wherein the delivery nozzle of the dispensing device 26 is connected to the flow divider 20 preferably via a flexible line of the main flow P1.

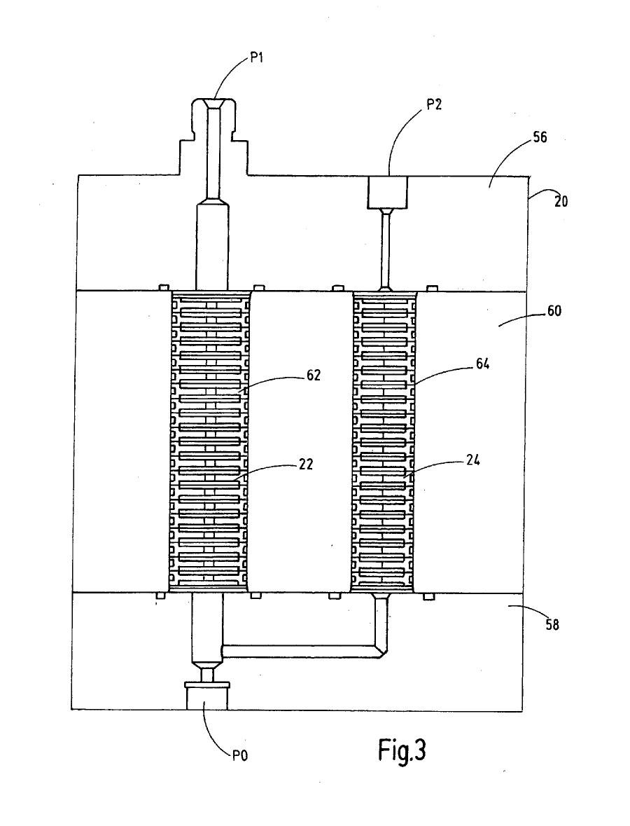

FIG. 3 shows, in the manner of a longitudinal sectional depiction, the flow divider 20 according to FIG. 1. Extending between two end plates 56, 58 is a receiving body 60 having two through-holes, in which individual diaphragm bodies 62, 64 are received to form the overall diaphragms 22 or 24 of the flow divider 20. To obtain a pressure value drop Δp of 5 bar inside the flow divider 20 from the inlet side P0 to the outlet side both for the main flow P1 and for the secondary flow P2, twenty diaphragm bodies 62 or 64 are arranged in each receiving channel of the central receiving body 60.

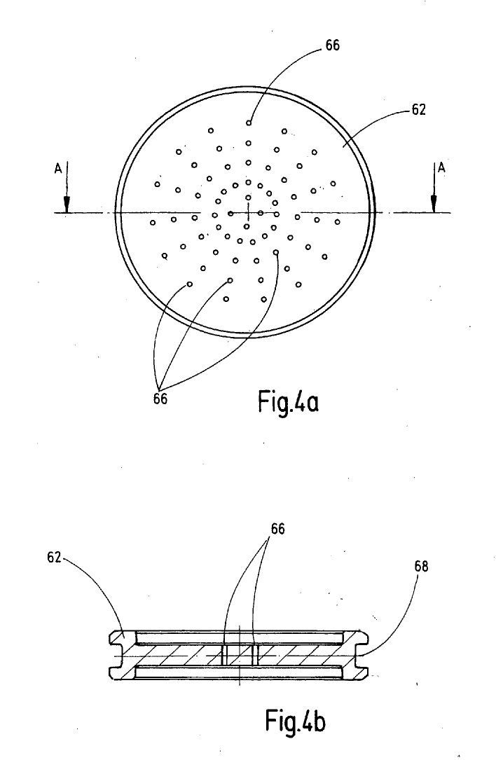

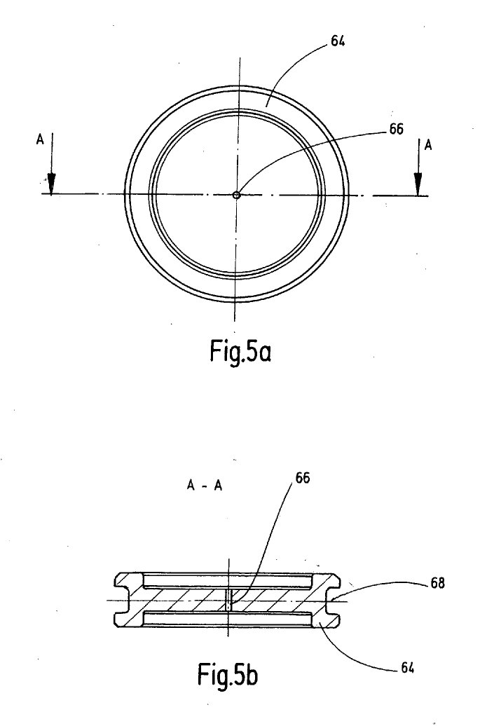

To obtain the described division between the secondary flow P2 and the main flow P1 of 1:64, the diaphragm body 62 illustrated by way of an example in FIGS. 4a, 4b has a plurality of individual diaphragm bores 66, wherein, with respect to the desired division ratio, 64 diaphragm bores 66 are evidently used. In accordance with the depiction according to FIGS. 5a and 5b, only one in particular centrally arranged diaphragm bore 66 is logically then used for the respective diaphragm body 64, in order to obtain an individual redispensable gas portion in the secondary flow P2.

As FIG. 3 furthermore shows, the top end plate 56 has connection options for the main flow P1 and the secondary flow P2 and the bottom end plate 58 has an inlet P0 for connection to the filling station dispensing network 12. All of the diaphragm bodies 62, 64 are sealed and held in position at the outer circumference by of ring seals, which can be received in groove-shaped recesses 68 (cf. the sectional depictions along the line A-A according to FIGS. 4b and 5b), which situation is not depicted in greater detail. Furthermore, the channels for receiving the respective diaphragm bodies 62, 64 are sealed at the respective end of the central receiving body 60 by conventional ring seals, which are not depicted in greater detail, relative to the top and bottom end plate 56, 58, as depicted in FIG. 3. Each diaphragm body 62, 64 of a category, in other words, provided in each case with 64 bores or only one diaphragm bore 66, is constructed as inexpensively producible identical parts and is formed temperature-resistant and high pressure-tight.

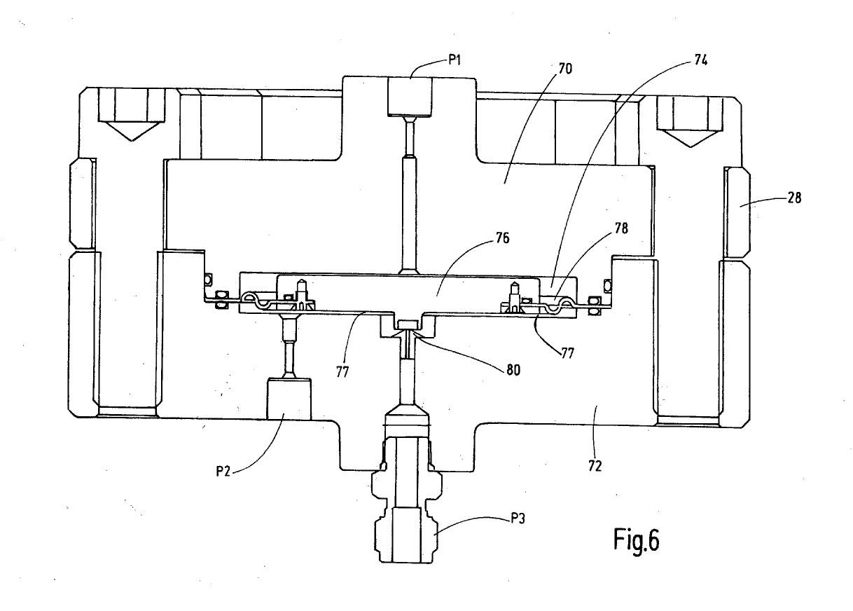

The longitudinal sectional depiction according to FIG. 6 relates to a schematic depiction of the differential control valve 28 used in FIG. 1 and shows the connection points for the main flow P1, the secondary flow P2 and for the measuring line P3. In view of the high pressures and the low temperatures, the differential control valve 28 is formed screwed in a flange construction in a particularly robust manner. Enclosed between a top flange part 70 and a bottom flange part 72 is a hollow chamber 74 with a mobile valve part 76 of the valve plate kind.

The valve plate 76 is surrounded at the edge sides by a bellows membrane 78, which extends in a planar manner, which engages at the edges between the two flange parts 70, 72 and which is fixed there in an appropriately sealed manner. The valve plate 76 is able to realize a small stroke inside the hollow chamber 74. In the raised position, valve plate 76 releases a valve seat 80 of PEEK steel, which has a fluid-conducting connection to the measuring line P3. During operation of the differential control valve 28, in view of the rapid and constant infeed of the pressure in the secondary flow P2 compared with the main flow P1, the valve plate 76 will, depending on the extraction situation at the delivery nozzle 26, start to oscillate. If appropriate, with a frequency of 100 Hz for example, in other words, 100 oscillations per second, valve plate 26 releases or shuts off the fluid flow 77 between the secondary flow P2 and the measuring line P3 via the valve seat 80. In this way, a gas amount in the secondary flow P2 with the same pressure as in the main flow P1 is conveyed “in a quantized form” to the measuring line P3 for subsequent measured value processing by the gas meter 36 and the volume converter 38.

The holding shut of the control valve 28 in its unactuated neutral position, symbolically depicted in FIG. 1 by the pressure spring 32, occurs by a partial suction at the valve seat 80 by the measuring line P3. An effect of the sort is known from bathtub plugs during plughole closing or opening by those plugs, which are then frequently briefly sucked up by the plughole opening. Very advantageously, the components of the differential control valve 28 are all designed as mechanical components, in other words, without electronics, which plays a significant role in view of the high flammability of the hydrogen.

The low pressure gas meter 36 in FIG. 2 is formed as a rotary piston gas meter. According to the latest data sheet issued by the company Itron, from whom this gas meter can be purchased under the trademark name Delta®, permits precise gas amount determination, even in the case of intermittent operation, and which, in particular in the case of a low pressure application, can determine gas amounts in a highly precise manner on the basis of the volume or the amount. A volume converter 38, which can also be purchased from the company Itron, which is available under the trade name CORUS PTZ, also permits, according to the data sheet specification, an integrated data storage acquisition and analysis. That CORUS converter 38 converts the gas amount measured by the gas meter 36 during operation into the corresponding volume under standard conditions. In its microprocessor determines the compressibility factor and also the conversion factor and the reevaluated gas amount from the operating values for amount, pressure and temperature. In this way, determining in a precise commercial manner at the dispensing side by the delivery nozzle as a component of the dispensing device 26 the amount of gas dispensed at the filling station which is relevant for determining the purchase price is possible. The method according to the invention and the associated measuring device thus for the first time allow a practical dispensing at filling stations of hydrogen for end users to be reliably undertaken, with the end users then only having to pay for the gas amount that they have actually filled their vehicle with.

While one embodiment has been chosen to illustrate the invention, it will be understood by those skilled in the art that various changes and modifications can be made therein without departing from the scope of the invention as defined in the claims.

1-10. (canceled)

11. A method for determining a gas amount dispensed by a dispensing device, comprising the steps of:
branching off a part of a main flow flowing toward a dispensing device by a flow divider to provide a secondary flow, the flow divider being mounted upstream of the dispensing device in a direction of gas mass flow; and
quantitatively measuring the secondary flow by a gas meter.

12. A method according to claim 11 wherein
the main flow is hydrogen gas.

13. A method according to claim 11 wherein
a total gas mass flow upstream of the flow divider is proportionally divided by the flow divider at a specifiable ratio of the secondary flow to the main flow.

14. A method according to claim 13 wherein
a gas amount in the secondary flow is smaller than a gas amount in the main flow and is adjusted by a differential control valve on an outlet side of the differential central valve to a respective pressure in the main flow independently of an actuation status of the dispensing device.

15. A method according to claim 14 wherein
a gas pressure in the secondary flow is higher than a gas pressure in the main flow; and
the differential control valve is a pressure control valve opening a measuring line into which the gas amount in the secondary flow is discharged until a pressure balance is restored in the main flow and in the secondary flow.

16. A method according to claim 15 wherein
the gas amount in the measuring line is expanded and tempered by a heat exchanger.

17. A method according to claim 16 wherein
the gas amount in the measuring line is brought to ambient temperature

18. A method according to claim 16 wherein
the gas amount in the measuring line is supplied to the gas meter after being expanded and tempered by the heat exchanger; and
the gas meter is connected at an outlet side thereof via a dispensing line to a prestressing device such that the gas amount discharged from the gas meter into the dispensing line proportionally corresponds to the gas amount discharged in the main flow by the dispensing device.

19. A method according to claim 18 wherein
the gas meter comprises a low pressure gas meter.

20. A method according to claim 18 wherein
the prestressing device comprises a check valve.

21. A method according to claim 11 wherein
an electronic volume converter is connected to a gas meter such that a pressure and a temperature of a gas amount in the gas meter is determined for precisely calibrated conversion of the gas amount in the gas meter to standard cubic measurements as an amount dispensed by the dispensing device.

22. A method according to claim 18 wherein
the gas amount discharged from the gas meter into the dispensing device is discharged into at least one of a surrounding environment via a chimney or to a tank from which the dispensing device takes stored gas.

23. A measuring device for determining a gas amount dispensed by a dispensing device, the measuring device comprising:
a gas dispenser;
a flow divider connected to said dispenser upstream of said dispenser;
a differential control valve connected to said flow divider downstream of said flow divider; and
a gas meter connected to said differential control valve downstream of said differential control valve.

24. A measuring device according to claim 23 wherein
a volume converter is connected to said gas meter;
a prestressing device is connected to said gas meter downstream of said gas meter; and
a tank is connected to said flow divider upstream of said flow divider.
